(19) United States
(12) Patent Application Publication
(10) Pub. No.: US 2002/0178343 A1
(43) Pub. Date: Nov. 28, 2002

(54) Personal digital assistant for connecting with a digital image capture device

(76) Inventors: Chu-Chia Tsai, Tapei Hsien (TW); Cheng-Hsin Sung, Tapei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/063,751

(22) Filed: May 10, 2002

(30) Foreign Application Priority Data
May 11, 2001 (TW) 090111376

(51) Int. Cl. G06F 15/76

(52) U.S. Cl. 712/1

(57) ABSTRACT

A PDA for connecting with a digital image capture module. The PDA includes a connecting device and attaching devices that form electrical and mechanical connections between the PDA and the digital image capture module, which includes corresponding devices. As described, the PDA becomes a tool with extended digital image capturing functions.

### BACKGROUND OF INVENTION

1. Field of the Invention

The present invention relates to a PDA (personal digital assistant), and more particularly, to a PDA for connecting with a selectively installed digital image capture device to provide some specific image-capturing function.

2. Description of the Prior Art

A PDA has a suitable size for carrying, an adequate memory, an operating ability, and a large enough LCD (liquid crystal display) panel to display results satisfactorily. It is becoming more popular as a portable electrical device and recently, a main trend product in information appliances.

A Palm Series, whose memory size ranges from 8 MB to 32 MB and offers models with a color or black-and-white LCD panel, occupies the largest market-share. The standby time of the Palm Series can last up to one week. The Palm Series also provides a connecting cable for digital data interchange between the PDA and a PC (personal computer). However, the PDA has a drawback. It is the lack of extend-ability to peripheral equipment. This influences the efficiency of using the PDA.

A digital camera and a digital video camera are the two dominating products in the portable electrical device field for connecting with a digital image capture device. An analog image, captured by the cameras lens, is processed by a chip into a digital data form and then stored in a predetermined memory. Similarly, the digital video camera captures consecutive analog images with its lens. These images are also processed by a chip into a digital data form and stored in a predetermined memory.

### SUMMARY OF INVENTION

It is therefore a primary objective of the claimed invention to provide a PDA for connecting with a digital image capture module to solve the extend-ability problem.

The claimed invention includes a PDA, a liquid crystal display panel, a slot installed on a first side of a housing of the PDA, a first connector including a plurality of contacts for transmitting electrical power and data installed on a second side of the housing of the PDA, and a digital image capture module which is detachable from the PDA.

It is an advantage of the claimed invention that the PDA for connecting with the digital image capture module can extend the PDA's ability to use peripheral equipment, effectively improving the usefulness of the PDA.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a PDA according to the present invention.

FIG. 1a is a three-dimensional drawing of the PDA of FIG. 1.

FIG. 1b is a front view of the PDA of FIG. 1.

FIG. 1c is a top view of the PDA of FIG. 1.

FIG. 1d is a bottom view of the PDA of FIG. 1.

FIG. 1e is a left-hand-side view of the PDA of FIG. 1.

FIG. 1f is a right-hand-side view of the PDA of FIG. 1.

FIG. 1g is a rear view of the PDA of FIG. 1.

FIG. 2 is a schematic diagram of a digital image capture module according to the present invention.

FIG. 2a is a three-dimensional drawing of the digital image capture module of FIG. 2.

FIG. 2b is a front view of the digital image capture module of FIG. 2.

FIG. 2c is a top view of the digital image capture module of FIG. 2.

FIG. 2d is a bottom view of the digital image capture module of FIG. 2.

FIG. 2e is a left-hand-side view of the digital image capture module of FIG. 2.

FIG. 2f is a right-hand-side view of the digital image capture module of FIG. 2.

FIG. 2g is a rear view of the digital image capture module of FIG. 2.

FIG. 3 is a state diagram of a combination between the PDA of FIG. 1 and the digital image capture module of FIG. 2.

FIG. 4 is another state diagram of a combination between the PDA of FIG. 1 and the digital image capture module of FIG. 2.

### DETAILED DESCRIPTION

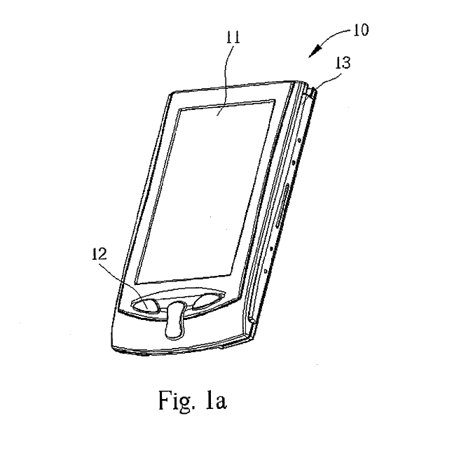

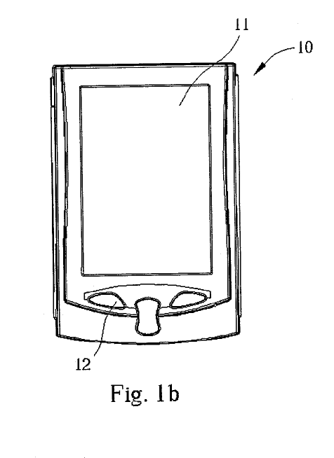

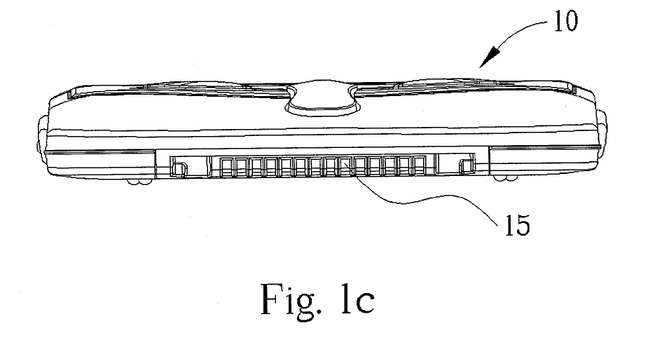

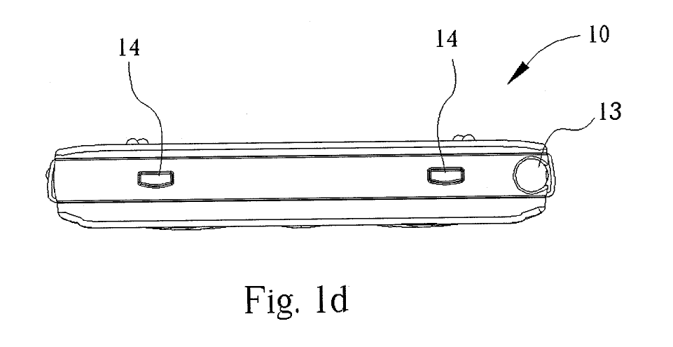

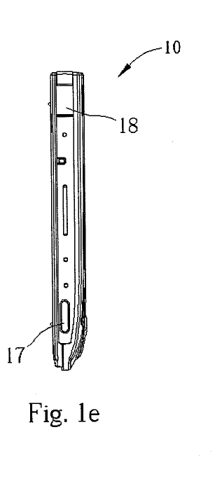

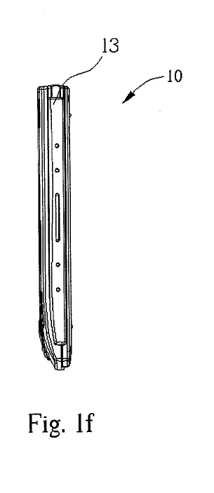

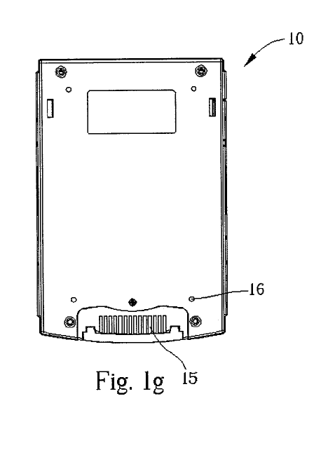

Please refer to FIG. 1 for an illustration of a PDA 10, which is a portable digital electrical device, with memory, a display device, and an operating processor. The data, which is usually input by touching the panel with a handpen (not shown), is transformed into a digital form and stored in memory. The PDA 10 has a wide application and generally serves as an electrical book, an electrical notebook, or an electrical business card album. Of course, the PDA 10 can also interchange data with another PDA or a PC by wire or by a wireless transmission port.

As shown in FIG. 1, the PDA 1 0 according to the present invention, comprises a housing 19, an LCD (liquid crystal display) panel 11, operating buttons 12, a handpen slot 13, a pair of engaging slots 14, a first connector 15, a pair of protrusions 16, a switch 17, and an infrared transmitter 18. The LCD panel 11 occupies as large an area as possible of the housing 19 to better display results. Disposed on the same side of the housing 19 as the LCD panel 11, several operating buttons 12 provide specific auxiliary operations, such as paging, executing a program, and cursor movement. The handpen is the most important input device. Therefore, there is the handpen slot 13 disposed on the right-hand-side of the housing 19 and is used for safekeeping of the handpen when not in use. The switch 17 is used to turn on or off the PDA 10. The infrared transmitter 18 provides a wireless transmission function. The PDA 10, of course, can be assembled with other built-in transmission modules, such as a blue-tooth chip module or an IEEE 802.11 module.

The pair of engaging slots 14 is located on an end of the housing 19. The first connector 15 and the pair of protrusions 16 are formed on a second side of the housing 19. The first connector 15 as shown in FIG. 1g, comprises 14 holes and serves as an electrical power and data transmitter. The first connector 15 can be used with a charger to charge the PDA”s 10 built-in battery. Additionally, the PDA 10 can interchange digital information with a PC using the first connector 15. According to the present invention, the first connector 15 can also be used to connect the PDA 10 with a digital image capture device. FIG. 1c illustrates that the first connector 15 forms an L-shaped socket on housing 19 to mate with a connector on the digital image capture module, fixing the capture module on the housing 19. The capture module and the connection of the capture module are described in more detail in the following paragraphs.

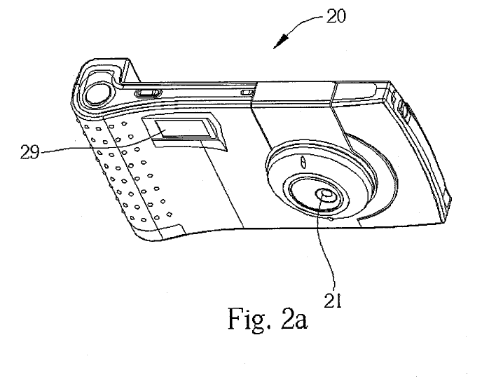

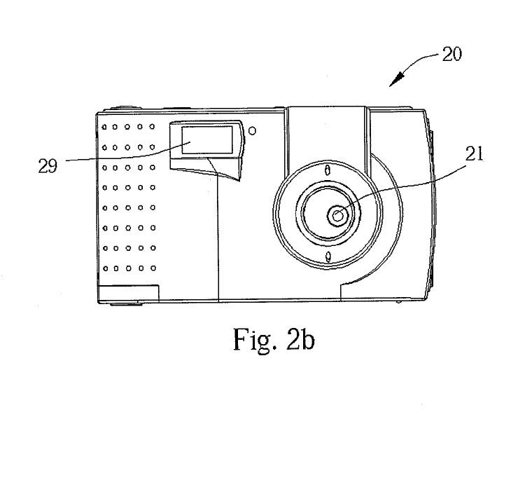

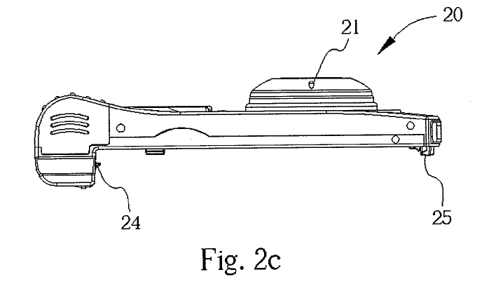

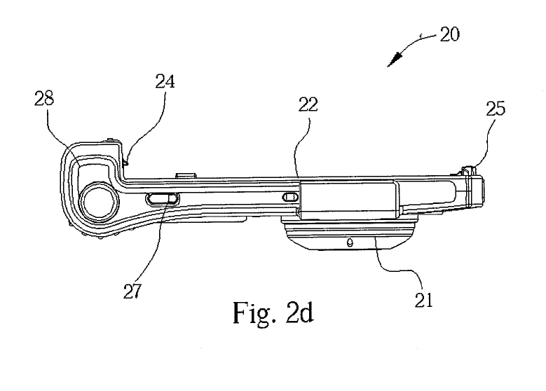

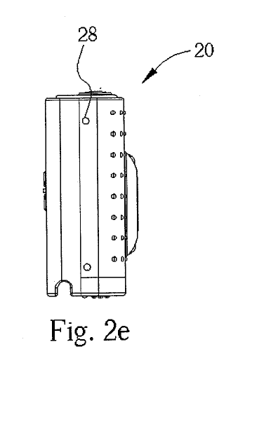

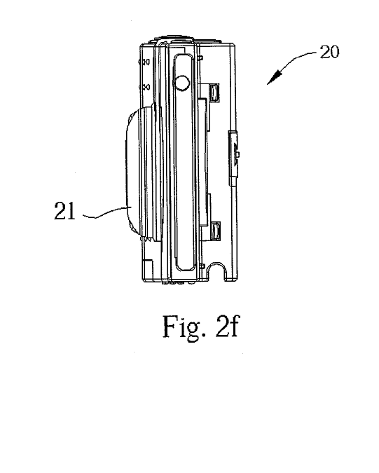

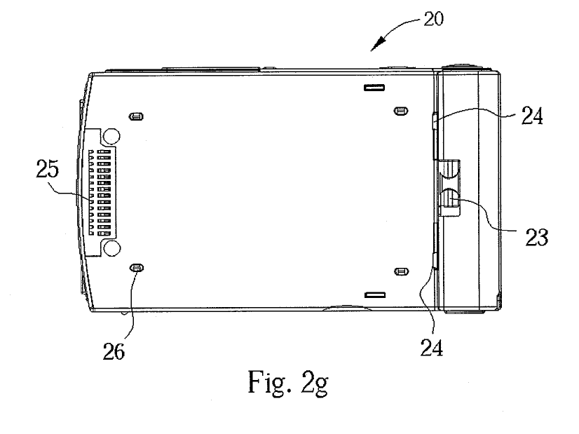

FIG. 2 illustrates a structure of the capture module 20. The capture module 20 comprises a case 30, a movable lens unit 21, a pivot 22 between the lens unit 21 and the case 30, release buttons 23 which are formed on a second side of the case 30, a pair of latches 24 which are mated with the engaging slots 14 of the PDA 10, a second connector 25 which is mated with first connector 15 of the PDA 10, a pair of sockets 26, a switch 27, a chassis 28, and a flash unit 29. The existing PDA 10 comprises a computer and a wireless communication function. Therefore, the PDA 10, when combined with the capture module 20, can serve as a digital camera in a video conference. During a video conference, the LCD panel 11 and the image capturing lens unit 21 should point in the same direction, allowing two-way visual communication via a wireless communication transmission. This is why the present invention comprises an apparatus allowing the position of the lens unit 21 to be adjusted.

Shown as in FIG. 2, the lens unit 21, connected to the mainframe of the case 30 by way of pivot 22, will rotate from 0 degrees to 180 degrees allowing the lens unit 21 to point in the same direction as the LCD panel 11. The direction of lens unit 21 can be further adjusted by repositioning the PDA 10.

The most obvious difference between the capture module 20 and an ordinary digital camera is that the capture module 20 does not comprise memory or a display panel. Therefore, the capture module 20 does not contain a digital image capturing function until connected to the PDA 10. The above combination uses the PDAs 10 built-in drive program. The LCD panel 11 will serve as a display panel and the image captured by the above combination will be stored in memory. The other parts of the capture module 20, such as the flash unit 29, all perform the same purpose as those in a conventional digital camera.

The capture modules 20 second connector 25 has 14 pins and mates with the first connector 15 of the PDA 10. The second connector 25 and the first connector 15 are used to transmit electrical power or data. The pair of sockets 26 on the case 30 is mated with the protrusions 16 disposed on the second side of the housing 19, so the case 30 can be accurately positioned on the housing 19. When users attach the capture module 20 to the PDA 10, the L-shaped movable latches 24 will enter the engaging slots 14 and the capture module 20 will fix onto the PDA 10. When users want to remove the capture module 20 from the PDA 10, pressing the release buttons 23 will move the latches 24 to a release position, allowing easy removal of the capture module 20 from the PDA 10.

The capture module 20 can be turned on or off by the switch 27. Of course, the PDAs 10 operating system needs a built-in drive program or a plugn-play model for the capture module 20 to function.

It is worthwhile to notice that the capture module 20 comprises a chassis 28 that is approximately perpendicular to the capture module”s 20 main frame and is used to cradle the PDA 10. Thus, the capture module 20 will combine with the PDA 10 more completely and the user will feel the combination easier to operate. Of course, the PDA 10 also contains a built-in plugn-play drive program. When the capture module 20 is plugged into the PDA 10, the PDA”s 10 drive program will operate the capture modules 20 digital image capturing function and display a captured image on the LCD panel 11.

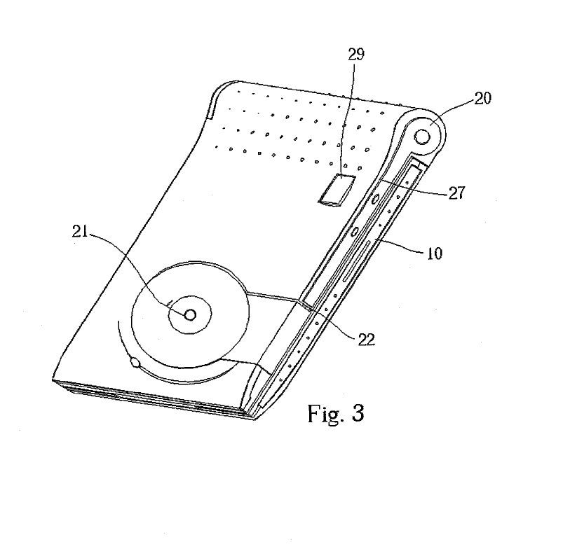

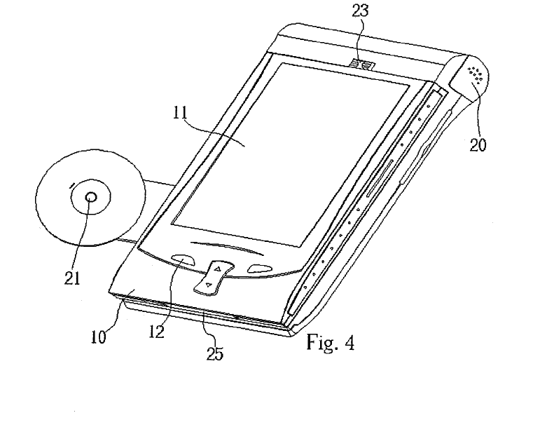

FIG. 3 illustrates an assembled state diagram according to the present invention. The combination of the PDA 10 and the capture module 20 is used exactly the same way as using a digital camera. A digital image signal captured by the capture module 20 is transmitted to the PDA 10 through a connection between the first connector 15 and the second connector 25. This signal is shown on the LCD panel 11 and directly stored into memory. FIG. 4 illustrates another assembled state diagram according to the present invention. The rotation of the lens unit 21 can be adjusted through the PDAs 10 position and can also be set to a specified angle. As shown in FIG. 4, the lens unit 21 has been rotated exactly 180 degrees. In this configuration, the LCD panel 11 and the image capturing lens unit 21 point in the same direction allowing two-way visual communication via a wireless communication transmission.

In contrast to the prior art, the present invention can provide a PDA that can connect with a digital image capture module, solving the problem of insufficient extend-ability to peripheral equipment.

Following the detailed description of the present invention, those skilled in the art will readily observe that numerous modifications and alterations of the device may be made while retaining the teachings of the invention. For example, the other end of the digital image capture module 30 can form a first connector 15 to attach to other modules allowing the PDA 10 to simultaneously perform more functions. Accordingly, the above disclosure should be construed as limited only by the metes and bounds of the appended claims.

What is claimed is:

1. A personal digital assistant comprising:
a housing;
a liquid crystal display panel for displaying information stored in the personal digital assistant;
a slot installed on a first side of the housing;
a first connector comprising a plurality of contacts installed on a second side of the housing for transmitting electric power and data; and
a digital image capture device which is detachable from the personal digital assistant comprising:
a latch for matching with the slot;
a release button; and
a second connector corresponding to the first connector, the second connector comprising a plurality of corresponding contacts for transmitting data.

2. The personal digital assistant of claim 1 wherein when the release button of the digital image capture device is pressed, the latch is moved to a release position.

3. The personal digital assistant of claim 1 further comprising a plurality of protruding plugs installed on a surface of the housing, and the digital image capture device further comprising a plurality of sockets corresponding to the protruding plugs of the personal digital assistant for precisely engaging with the personal digital assistant.

4. The personal digital assistant of claim 1 wherein the contacts of the first connector comprises fourteen pins, and the contacts of the second connector comprises fourteen receiving holes for matching with the corresponding pins of the first connector.

5. The personal digital assistant of claim 1 wherein the digital image capture device further comprises a switch for switching on or switching off the digital image capture device.

6. The personal digital assistant of claim 1 wherein the digital image capture device further comprises a base which is approximately perpendicular with the housing of the personal digital assistant for leaning on the personal digital assistant when the digital image capture device is connected to the personal digital assistant.

7. The personal digital assistant of claim 1 wherein the digital image capture device further comprises a movable lens unit which is capable of being adjusted to a predetermined position for capturing images.

8. The personal digital assistant of claim 7 wherein the lens unit is connected to the digital image capture device via a pivot.

9. A personal digital assistant comprising:
a first housing;
a liquid crystal display panel for displaying information stored in the personal digital assistant;
a slot installed on a first side of the first housing;
a first connector comprising a plurality of contacts installed on a second side of the first housing for transmitting electric power and data; and
a digital image capture device which is detachable from the personal digital assistant comprising:
a second housing;
a lens unit which is movable for capturing images;
a pivot connected to the lens unit;
a latch for matching with the slot;
a base which is approximately perpendicular with the second housing;
a release button installed on the second housing; and
a second connector corresponding to the first connector, the second connector comprising a plurality of corresponding contacts for transmitting data.

10. The personal digital assistant of claim 9 wherein when the release button of the digital image capture device is pressed, the latch is moved to a release position.

11. The personal digital assistant of claim 9 further comprising a plurality of protruding plugs installed on a surface of the first housing, and the digital image capture device further comprising a plurality of sockets corresponding to the protruding plugs of the personal digital assistant for precisely engaging with the personal digital assistant.

12. The personal digital assistant of claim 9 wherein the contacts of the first connector comprises fourteen pins, and the contacts of the second connector comprises fourteen receiving holes for matching with the corresponding pins of the first connector.

13. The personal digital assistant of claim 9 wherein the digital image capture device further comprises a switch for switching on or switching off the digital image capture device.

14. The personal digital assistant of claim 9 wherein the lens unit is connected to the digital image capture device via a pivot.
